(19) United States
(12) Patent Application Publication
(10) Pub. No.: US 2014/0143658 A1
(43) Pub. Date: May 22, 2014

(54) Method And System For Displaying Network Medium Information

(71) Applicant: TENCENT TECHNOLOGY (SHENZHEN) COMPANY LIMITED, Shenzhen (CN)

(72) Inventors: Chaojian ZHOU, Shenzhen (CN); Longyun ZHU, Shenzhen (CN); Shenglong LING, Shenzhen (CN); Jie YANG, Shenzhen (CN)

(73) Assignee: TENCENT TECHNOLOGY (SHENZHEN) COMPANY LIMITED, Shenzhen (CN)

(21) Appl. No.: 14/162,803

(22) Filed: Jan. 24, 2014

Related U.S. Application Data
(63) Continuation of application No. PCT/CN2012/077891, filed on Jun. 29, 2012.

(30) Foreign Application Priority Data
Jul. 28, 2011 (CN) 201110214115.7

(51) Int. Cl. G06F 17/21

(52) U.S. Cl. CPC G06F 17/211
USPC 715/243

(57) ABSTRACT

A medium information displaying apparatus located at a terminal device and a medium information playing apparatus located at a network side. The terminal device searches display positions of a display medium, obtains identification information of at least one display position, sending an information playing request to a network side after adding the obtained identification information into the information playing request. The network side obtains the identification information in the information playing request, searches for display data corresponding to the at least one display position, sends an information playing response to the terminal device after adding the identification information and the display data into the information playing response. The terminal device displays medium information on the display position of the display medium according to the display data corresponding to the at least one display position.

### CROSS-REFERENCE TO RELATED APPLICATIONS

This application is a continuation of International Application No. PCT/CN2012/077891, filed on Jun. 29, 2012. This application claims the benefit and priority of Chinese Patent Application No. 201110214115.7, filed on Jul. 28, 2011. The entire disclosures of each of the above applications are incorporated herein by reference.

### FIELD

The present disclosure relates to data processing technologies and to a method and system for displaying network medium information on the Internet.

### BACKGROUND

This section provides background information related to the present disclosure which is not necessarily prior art.

Network medium information at least includes information carried by data codes and distributed on various display mediums of Internet systems. The display medium may be a web page, or an interface of a client. Currently, Internet technologies are concerned with effectively displaying the network medium information for specific users and effectively managing the displayed network medium information, and a system for distributing network medium information is provided. The system for distributing the network medium information is a data processing system for organizing, distributing, displaying, and managing the network medium information.

### SUMMARY

This section provides a general summary of the disclosure, and is not a comprehensive disclosure of its full scope or all of its features.

Various embodiments provide a method and system for displaying network medium information, so as to reduce data processing press of a network side in a system for distributing network medium information and reduce occupied network bandwidth resources.

The technical solutions are implemented as follows.

A method for displaying network medium information includes: searching, by a terminal device, display positions of a display medium; obtaining identification information of at least one display position; sending an information playing request to a network side after adding the identification information of the at least one display position into the information playing request;

receiving, by the network side, the information playing request; obtaining the identification information of the at least one display position; searching for display data corresponding to the at least one display position according to the identification information of the at least one display position; sending an information playing response to the terminal device after adding the identification information of the at least one display position and the display data corresponding to the at least one display position into the information playing response;

receiving, by the terminal device, the information playing response; obtaining the identification information of the at least one display position and the display data corresponding to the at least one display position from the information playing response; and displaying medium information on the display position of the display medium according to the identification information of the at least one display position and the display data corresponding to the at least one display position.

A system for displaying network medium information includes a medium information displaying apparatus located at a terminal device and a medium information playing apparatus located at a network side; wherein

the medium information displaying apparatus comprises:

a searching module, searching display positions of a display medium and obtaining identification information of at least one display position;

a first sending module, sending an information playing request to the medium information playing apparatus after adding the identification information of the at least one display position into the information playing request;

a first receiving module, receiving information playing response from the medium information playing apparatus, and obtaining display data corresponding to the at least one display position from the information playing response;

a displaying module, displaying medium information on the display position of the display medium according to the display data and identification information corresponding to the at least one display position;

the medium information playing apparatus comprises:

a second receiving module, receiving the information playing request from the medium information displaying apparatus, and obtaining the identification information of the at least one display position;

a searching module, searching for the display data corresponding to the at least one display position according to the identification information of the at least one display position;

a second sending module, sending the information playing response to the medium information displaying apparatus after adding the identification information of the at least one display position and the display data corresponding to the at least one display position into the information playing response.

A method for displaying network medium information includes:

searching, by a terminal device, display positions of a display medium; obtaining identification information of at least one display position;

sending, by the terminal device, an information playing request to a network side after adding the identification information of the at least one display position into the information playing request;

receiving, by the terminal device, an information playing response from the network side; the information playing response comprising the identification information of the at least one display position and display data corresponding to the at least one display position;

obtaining, by the terminal device, the identification information of the at least one display position and the display data corresponding to the at least one display position from the information playing response; and

displaying, by the terminal device, medium information on the display position of the display medium according to the identification information of the at least one display position and the display data corresponding to the at least one display position.

Compared with the conventional solutions, the information of at least one display position on the same display medium, e.g., a web page, an interface of a software client, is added in the information playing request, and the information playing request is sent to the network side. For the same display medium, the network side only needs to send one information playing response, thereby reducing data processing press of the medium information playing apparatus at the network side of the network medium information distributing system, and reducing occupied network bandwidth resources.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating a conventional system for distributing network medium information.

FIG. 2 is a schematic diagram illustrating conventional processing when a display medium has more than one display position.

FIG. 3 is a schematic flowchart illustrating a method for displaying network medium information according to various embodiments.

FIG. 4 is a schematic flowchart illustrating a method for displaying network medium information according to various embodiments.

FIG. 5 is a schematic diagram illustrating processing when a display medium has more than one display position according to various embodiments.

FIG. 6 is a schematic diagram illustrating a system for displaying network medium information according to various embodiments.

FIG. 7 is a schematic diagram illustrating a searching module in an apparatus for displaying network medium information according to various embodiments.

FIG. 8 is a schematic diagram illustrating a displaying module in an apparatus for displaying network medium information according to various embodiments.

FIG. 9 is a schematic diagram illustrating a server for displaying network medium information according to various embodiments.

Corresponding reference numerals indicate corresponding parts throughout the several views of the drawings.

### DETAILED DESCRIPTION

Example embodiments will now be described more fully with reference to the accompanying drawings.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of embodiments anywhere in this specification, including embodiments of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

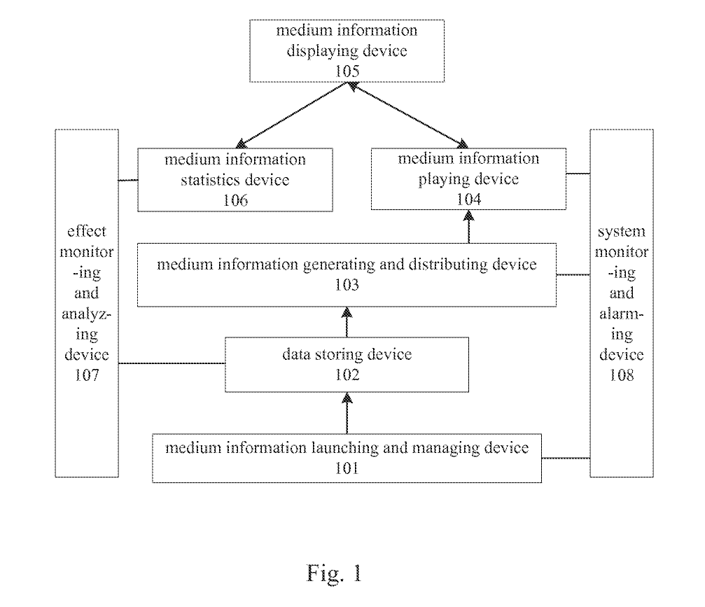

The description will be made of the embodiments in conjunction with the accompanying drawings in FIGS. 1-9. It should be understood that specific embodiments described herein are merely intended to explain the present disclosure, but not intended to limit the present disclosure. In accordance with the purposes of this invention, as embodied and broadly described herein, this invention, in one aspect, relates to method and apparatus for displaying network medium information.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

FIG. 1 is a schematic diagram illustrating a conventional system for distributing network medium information. As shown in FIG. 1, the system includes a medium information launching and managing device 101, a data storing device 102, a medium information generating and distributing device 103, a medium information playing device 104, a medium information displaying device 105, a medium information statistics device 106, an effect monitoring and analyzing device 107 and a system monitoring and alarming device 108.

The medium information launching and managing device 101 provides a human-machine interaction interface for a medium information manager, so that the medium information manager may manage display positions, manage medium information, and manage medium information orders, etc.

The data storing device 102 stores medium information data processed by the medium information launching and managing device 101.

The medium information generating and distributing device 103 obtains medium information data from the data storing device 102 and processes the obtained medium information data. The medium information generating and distributing device 103 also obtains display data needed by the medium information playing device 104, and sends the display data to the medium information playing device 104.

The medium information playing device 104 responds to an information playing request sent by the medium information displaying device 105, searches for display data on a display position designated in the information playing request and sends the display data to the medium information displaying device 105. The display data may be medium information materials, medium information URL, etc.

The medium information displaying device 105 is located in a medium displaying side, and sends the information playing request for each display position to the medium information playing device 104. The display position is a display location on the display medium that can be used to display the medium information, e.g., a position for displaying the medium information on a web page of a browser or client software (e.g. IM software) on a computer. After receiving the display data sent by the medium information playing device 104, the medium information displaying device 105 displays the medium information on the display position, and sends an exposure statistics request to the medium information statistics device 106. The exposure statistics request includes a display position identifier and a medium information order identifier.

After receiving the exposure statistics request, the medium information statistics device 106 counts the exposure number of the display position and the medium information order according to the display position identifier and the medium information order identifier included in the exposure statistics request. The exposure number is the number of displaying the medium information on the display medium.

The effect monitoring and analyzing device 107 and the system monitoring and alarming device 108 monitor and analyze display effect of the medium information, and monitor the running state of the system.

If one display medium has more than one display position, conventional operations are as follows. When a user opens the display medium, e.g., a web page or client software, the medium information displaying device 105 sends a request for obtaining display data for each display position to the medium information playing module 104, displays the medium information on the display position, and sends a exposure statistics request for each display position to the medium information statistics device 106.

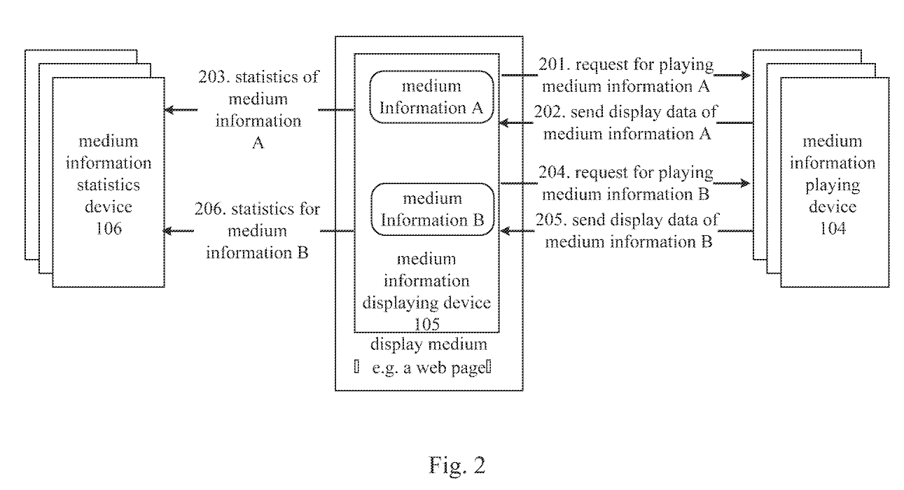

FIG. 2 is a schematic diagram illustrating conventional processing when a display medium has more than one display position. As shown in FIG. 2, a web page has two display positions, medium information A and medium information B. After a user opens the web page, the following operations are performed.

At 201, the medium information displaying device 105, which is used to display medium information, sends a request for playing medium information A to the medium information playing device 104.

At 202, after receiving the request, the medium information playing device 104 finds out display data of medium information A, and sends the display data to the medium information displaying device 105.

At 203, the medium information displaying device 105 displays medium information on a position of medium information A, and sends a request of exposure statistics for medium information A to the medium information statistics device 106.

At 204, the medium information displaying device 105 sends a request for playing medium information B to the medium information playing device 104.

At 205, after receiving the request, the medium information playing device 104 finds out display data of medium information B, and sends the display data to the medium information displaying device 105.

At 206, the medium information displaying device 105 displays medium information on a position of medium information B, and sends a request of exposure statistics for medium information B to the medium information statistics device 106.

According to the above conventional solutions, the following disadvantages are obtained.

In the conventional solutions, the medium information playing device is requested to provide the medium information data of each display position, and each request triggers a data processing procedure of the medium information playing device and response result information is generated. Hence, data processing press of the medium information playing device is large, and large amount of network bandwidth resources are occupied.

Further, in the conventional solutions, the medium information statistics device is requested to perform the data statistics operations for each display position, and each request triggers a data processing procedure of the medium information statistics device. Hence, the data processing press of the medium information statistics device is large, and large amount of network bandwidth resources are occupied.

Therefore, according to the conventional solutions, the data processing press of the medium information processing device at the network side of the system for distributing network medium information is large, such as the data processing press of the medium information playing device and medium information statistics device is large, and large amount of network bandwidth resources are occupied.

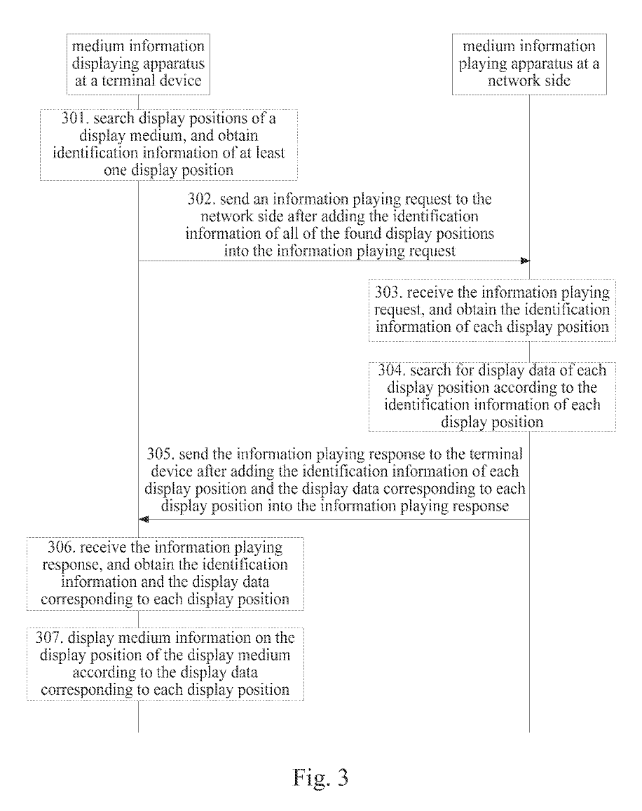

FIG. 3 is a schematic flowchart illustrating a method for displaying network medium information according to various embodiments. As shown in FIG. 3, operations of a terminal device is performed by a medium information displaying apparatus, and operations at a network side is performed by a medium information playing apparatus. The method includes the following processing.

At 301, the terminal device searches display positions of a display medium, and identification information of at least one display position is obtained. The display medium may be a web page, an interface of a software client, etc.

According to various embodiments, the display position is identified by using a preconfigured display position domain identifier in a source file of the display medium. At 301, the method for searching the display positions of the display medium includes the following process.

The source file of the display medium is searched for the preconfigured display position domain identifiers. When the display position domain identifier is searched out, the identification information of the display position is obtained according to the display position domain identifier. According to various embodiments, the display position domain identifier may be preconfigured as <tencent AD>. Each display position is represented by using the display position domain identifier and the identification information of the display position in the source file of the display medium. For example, display position A may be represented as <tencent AD> identification information of display position A </tencent AD>. According to various embodiments, the identification information of the display position is unique global identification information of the display position in a whole network medium information distributing system, and each item of the identification information of the display position uniquely indicates one display position.

At 302, the terminal device sends an information playing request to the medium information playing apparatus at the network side after adding the identification information of all of the found display positions into the information playing request.

At 303, the medium information playing apparatus receives the information playing request, and obtains the identification information of each display position.

At 304, the medium information playing apparatus searches for display data of each display position according to the identification information of each display position.

According to various embodiments, the identification information of the display position is taken as an index of the display data stored in the medium information playing apparatus at the network side. At 304, the display data may be quickly found according to the identification information of the display position. The display data may include obtaining address of medium information material, e.g., pictures, videos, etc., or may directly include text content of the medium information, or may further include clicking address of the medium information. The terminal device may obtain the medium information material, the text content of the medium information or the clicking address of the medium information according to the above display data.

Further, if the terminal device needs medium information order information, the medium information playing apparatus may further add a medium information order identifier corresponding to each display position into an information playing response, and sends the information playing response to the terminal device.

At 305, the medium information playing apparatus sends the information playing response to the medium information displaying apparatus at the terminal device after adding the identification information of each display position and the display data corresponding to each display position into the information playing response.

At 306, the medium information displaying apparatus receives the information playing response, and obtains the identification information of each display position and the display data corresponding to each display position.

At 307, the medium information displaying apparatus displays medium information on the display position of the display medium according to the display data corresponding to each display position.

According to various embodiments, the display position of the display medium is searched out according to the identification information of each display position. The medium information is obtained according to the display data corresponding to each display position. The medium information corresponding to a certain display position is displayed on the display position.

For example, if the display data includes the obtaining address (e.g., a URL) of the medium information material (e.g., pictures, videos, etc.), the medium information displaying apparatus obtains the medium information material, e.g., the pictures or video data, and displays the medium information on the display position of the web page or the software client.

According to various embodiments, the medium information displaying apparatus may be implemented by using client scripting language, e.g., Javascript language.

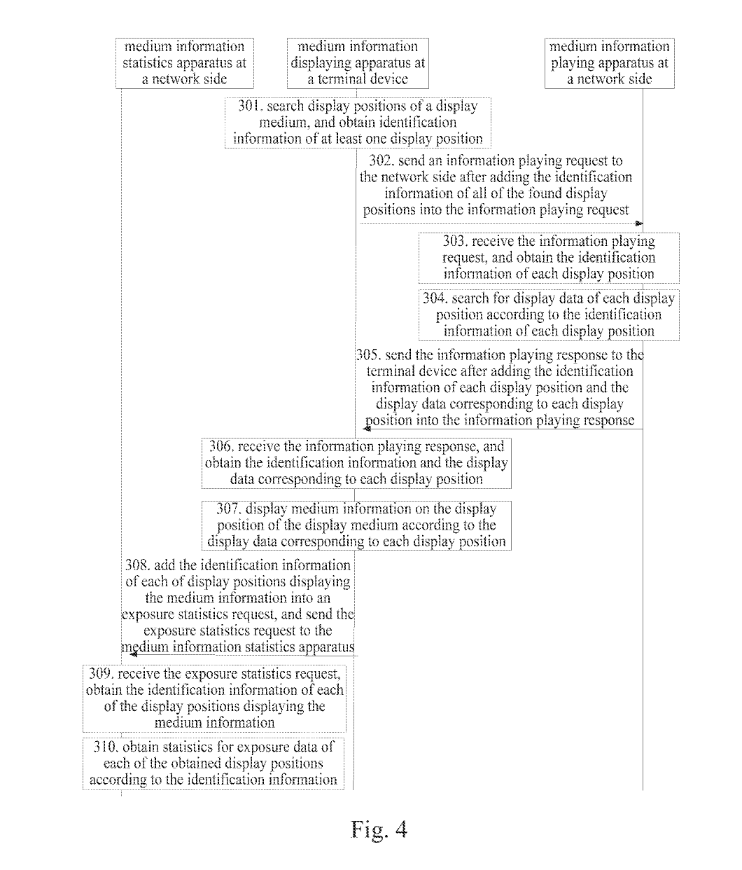

FIG. 4 is a schematic flowchart illustrating a method for displaying network medium information according to various embodiments. As shown in FIG. 4, besides the processing from 301 to 307, medium information statistics processing is added, a medium information statistics apparatus at the terminal device and a medium information statistics apparatus at the network side interact with each other. The medium information statistics process is as follows.

At 308, the medium information statistics apparatus at the terminal device adds the identification information of each of display positions displaying the medium information into an exposure statistics request, and sends the exposure statistics request to the medium information statistics apparatus at the network side.

At 309, the medium information statistics apparatus receives the exposure statistics request, obtains the identification information of each of the display positions displaying the medium information.

At 310, the medium information statistics apparatus obtains statistics for exposure data of each of the display positions according to the identification information of each of the display positions displaying the medium information.

According to various embodiments, if the medium information statistics apparatus needs to obtain exposure data of the medium information orders, at 304 and 305, the medium information playing apparatus further searches for a medium information order identifier corresponding to each display position, adds the searched out medium information order identifier into the information playing response, and sends the information playing response to the medium information displaying apparatus. The medium information displaying apparatus further obtains the medium information order identifier from the information playing response. At 308, the medium information displaying apparatus further adds the medium information order identifier corresponding to the display position displaying the medium information into the exposure statistics request, and sends the exposure statistics request to the medium information statistics apparatus. At 309 and 310, the medium information statistics apparatus further obtains the medium information order identifier corresponding to the display position displaying the medium information from the exposure statistics request, and obtains statistics for exposure data of the medium information order according to the medium information order identifier.

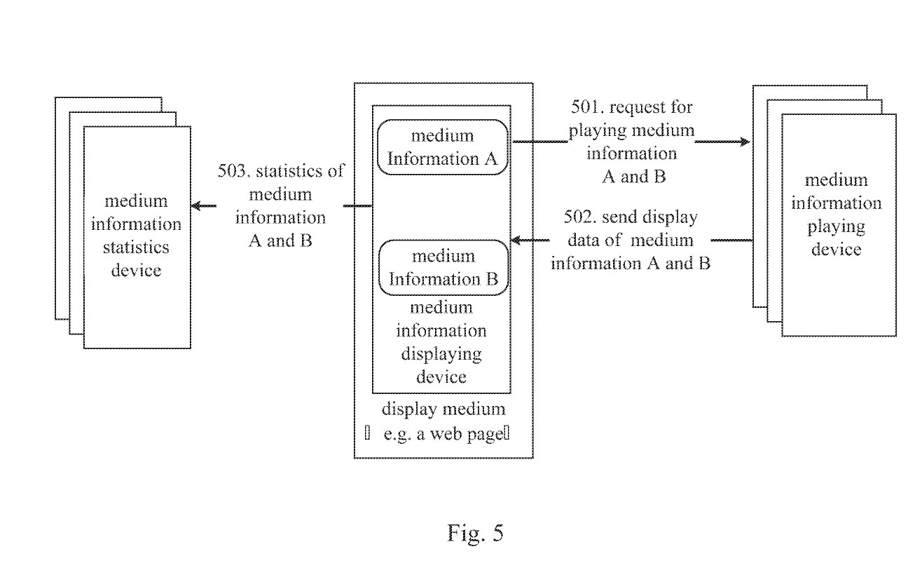

FIG. 5 is a schematic diagram illustrating processing when a display medium has more than one display position according to various embodiments. As shown in FIG. 5, a current network page includes two display positions, medium information A and medium information B. When a user opens the network page, the user requests to play medium information A and medium information B by using an information playing request 501, and the medium information playing apparatus returns display data of medium information A and medium information B by using an information playing response 502, thereby reducing data processing press of the medium information playing apparatus, and reducing occupied network bandwidth resources between the display medium and the medium information playing apparatus. Further, statistics of exposure information related to medium information A and medium information B is requested to be obtained by using an exposure statistics request 503, thereby, reducing data processing press of the medium information statistic apparatus, reducing occupied network bandwidth resources between the display medium and the medium information statistic apparatus.

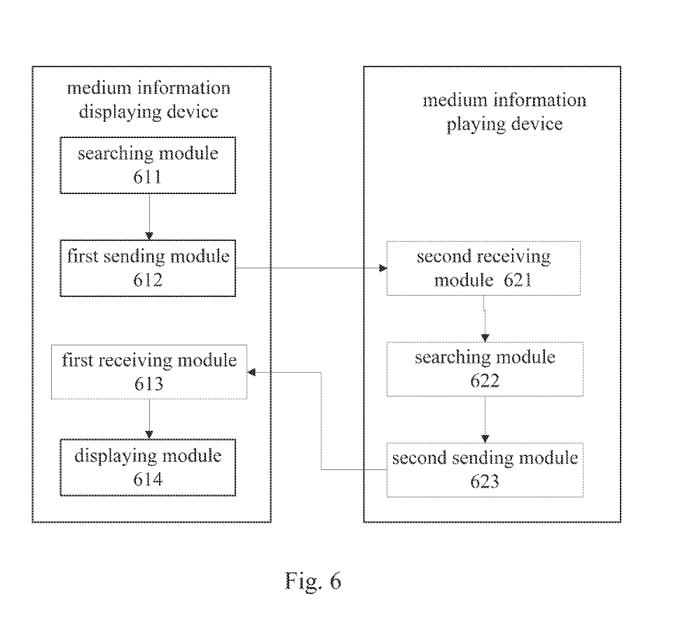

FIG. 6 is a schematic diagram illustrating a system for displaying network medium information according to various embodiments. As shown in FIG. 6, the system includes a medium information displaying apparatus at a terminal device and a medium information playing apparatus at a network side.

The medium information displaying apparatus includes a searching module 611, a first sending module 612, a first receiving module and a displaying module 614.

The searching module 611 searches display positions of a display medium and obtains identification information of at least one display position.

The first sending module 612 sends an information playing request to the medium information playing apparatus after adding the identification information of the at least one display position in the information playing request.

The first receiving module 613 receives information playing response from the medium information playing apparatus, and obtains display data corresponding to the at least one display position from the information playing response.

The displaying module 614 displays medium information on the display position of the display medium according to the display data and identification information corresponding to the at least one display position.

The medium information playing apparatus includes a second receiving module 621, a searching module 622, and a second sending module 623.

The second receiving module 621 receives the information playing request from the medium information displaying apparatus, and obtains the identification information of the at least one display position.

The searching module 622 searches for the display data corresponding to the at least one display position according to the identification information of the at least one display position.

The second sending module 623 sends the information playing response to the medium information displaying apparatus after adding the identification information of the at least one display position and the display data corresponding to the at least one display position in the information playing response.

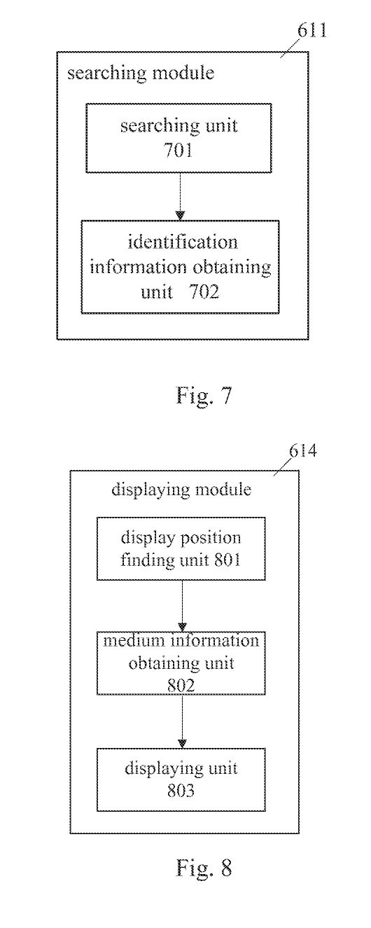

FIG. 7 is a schematic diagram illustrating a searching module in a medium information displaying apparatus according to various embodiments. As shown in FIG. 7, the searching module 611 includes a searching unit 701 and an identification information obtaining unit 702.

The searching unit 701 is to search a source file of the display medium for a preconfigured display position domain identifier.

The identification information obtaining unit 702 is to obtain the identification information of the display position behind the display position domain identifier, when the display position domain identifier is searched out.

FIG. 8 is a schematic diagram illustrating a displaying module in a medium information displaying apparatus according to various embodiments. As shown in FIG. 8, the displaying module 614 includes a display position finding unit 801, a medium information obtaining unit 802 and a displaying unit 803.

The display position finding unit 801 finds the at least one display position of the display medium according to the identification information of the at least one display position.

The medium information obtaining unit 802 obtains the medium information according to the display data corresponding to the at least one display position.

The displaying unit 803 displays the medium information obtained on the display position corresponding to the medium information.

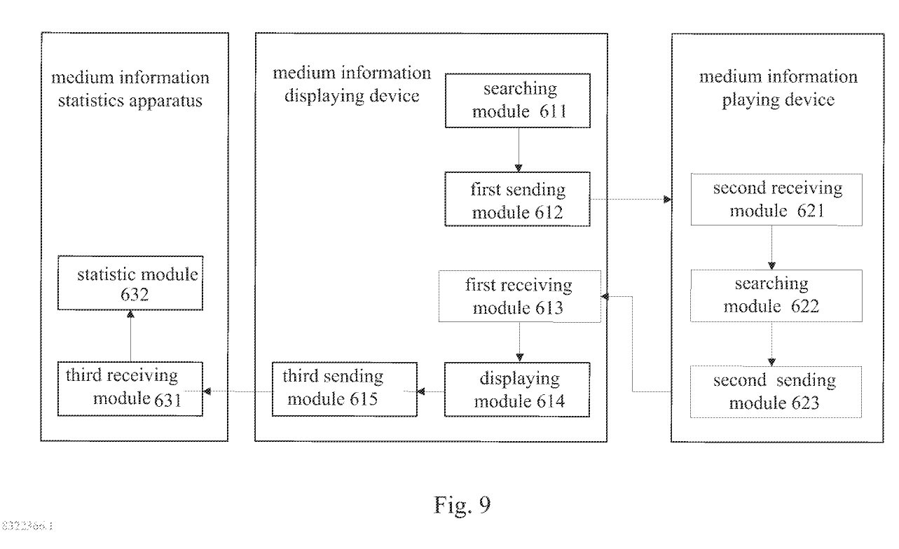

FIG. 9 is a schematic diagram illustrating a system for displaying network medium information according to various embodiments. As shown in FIG. 9, the apparatus further includes a medium information statistics apparatus at the network side. The medium information displaying apparatus further includes a third sending module 615 to send an exposure statistics request to the medium information statistics apparatus after adding related information of each of display positions displaying the medium information in the exposure statistics request.

The medium information statistics apparatus includes a third receiving module 631 and a statistics module 632.

The third receiving module 631 receives the exposure statistics request from the medium information displaying apparatus and obtains the related information of each of the display positions displaying the medium information.

The statistic module 632 obtains statistics according to the related information of each of the display positions displaying the medium information.

Compared with the conventional solutions, the information of at least one display position on the same display medium, e.g., a web page, an interface of a software client, is added in the information playing request, and the information playing request is sent to the network side. For the same display medium, the network side only needs to send one information playing response, thereby reducing data processing press of the medium information playing apparatus at the network side of the network medium information distributing system, and reducing occupied network bandwidth resources.

Further, the information of the more than one display position on the display medium are added in the exposure statistics request, and the exposure statistics request is sent to the network side, thereby, reducing data processing press of the medium information statistic apparatus at the network side, and reducing occupied network bandwidth resources.

The methods and modules described herein may be implemented by hardware, machine-readable instructions or a combination of hardware and machine-readable instructions. Machine-readable instructions used in the various embodiments disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which stores instructions to cause a machine to execute a method as described herein. Specifically, a system or apparatus having a storage medium that stores machine-readable program codes for implementing functions of any of the above embodiments and that may make the system or the apparatus (or CPU or MPU) read and execute the program codes stored in the storage medium.

In this situation, the program codes read from the storage medium may implement any one of the above embodiments, thus, the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM, and so on. Optionally, the program code may be downloaded from a server computer via a communication network.

Alternatively to the program codes being executed by a computer, at least part of the operations performed by the program codes may be implemented by an operation system running in a computer following instructions based on the program codes to realize a technical scheme of any of the above embodiments.

In addition, the program codes implemented from a storage medium are written in a storage in an extension board inserted in the computer or in a storage in an extension unit connected to the computer. In this embodiment, a CPU in the extension board or the extension unit executes at least part of the operations according to the instructions based on the program codes to realize a technical scheme of any of the above embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying network medium information, comprising:
searching, by a terminal device, display positions of a display medium; obtaining identification information of at least one display position; sending an information playing request to a network side after adding the identification information of the at least one display position into the information playing request;
receiving, by the network side, the information playing request; obtaining the identification information of the at least one display position; searching for display data corresponding to the at least one display position according to the identification information of the at least one display position; sending an information playing response to the terminal device after adding the identification information of the at least one display position and the display data corresponding to the at least one display position into the information playing response;
receiving, by the terminal device, the information playing response; obtaining the identification information of the at least one display position and the display data corresponding to the at least one display position from the information playing response; and displaying medium information on the display position of the display medium according to the identification information of the at least one display position and the display data corresponding to the at least one display position.

2. The method of claim 1, wherein searching the display positions of the display medium and obtaining the identification information of the at least one display position comprises:
searching a source file of the display medium for a preconfigured display position domain identifier;
obtaining the identification information of the display position behind the display position domain identifier, when the display position domain identifier is searched out.

3. The method of claim 1, wherein displaying the medium information on the display position of the display medium according to the identification information of the at least one display position and the display data corresponding to the at least one display position comprises:
finding the at least one display position of the display medium according to the identification information of the at least one display position;
obtaining the medium information according to the display data corresponding to the at least one display position; and
displaying the medium information obtained on the display position corresponding to the medium information.

4. The method of claim 1, further comprising:
after displaying the medium information on the display position of the display medium according to the display data corresponding to the at least one display position,
sending, by the terminal device, an exposure statistics request to the network side after adding identification information of each of display positions displaying the medium information into the exposure statistics request;
receiving, by the network side, the exposure statistics request;
obtaining the identification information of each of the display positions displaying the medium information;
obtaining statistics for exposure data of each of the display positions displaying the medium information according to the identification information of each of the display positions displaying the medium information.

5. The method of claim 1, further comprising:
after receiving the information playing request,
searching for, by the network side, a medium information order identifier corresponding to each of the at least one display position;
adding a medium information order identifier searched out in the information playing response;
sending the information playing response to the terminal device;
adding, by the terminal device, an medium information order identifier corresponding to each of the display positions displaying the medium information in the exposure statistics request, when generating the exposure statistics request comprising the identification information of each of display positions displaying the medium information;
obtaining, by the network side, the medium information order identifier corresponding to each of the display positions displaying the medium information, after receiving the exposure statistics request;
obtaining statistics for exposure data of medium information orders according to the medium information order identifier corresponding to each of the display positions displaying the medium information.

6. The method of claim 1, wherein the identification information of the display position comprises: unique global identification information of the display position in a network medium information distributing system.

7. A system for displaying network medium information, comprising: a medium information displaying apparatus located at a terminal device and a medium information playing apparatus located at a network side; wherein
the medium information displaying apparatus comprises:
a searching module, searching display positions of a display medium and obtain identification information of at least one display position;
a first sending module, sending an information playing request to the medium information playing apparatus after adding the identification information of the at least one display position into the information playing request;
a first receiving module, receiving information playing response from the medium information playing apparatus, and obtaining display data corresponding to the at least one display position from the information playing response;
a displaying module, displaying medium information on the display position of the display medium according to the display data and identification information corresponding to the at least one display position;
the medium information playing apparatus comprises:
a second receiving module, receiving the information playing request from the medium information displaying apparatus, and obtaining the identification information of the at least one display position;
a searching module, searching for the display data corresponding to the at least one display position according to the identification information of the at least one display position;
a second sending module, sending the information playing response to the medium information displaying apparatus after adding the identification information of the at least one display position and the display data corresponding to the at least one display position into the information playing response.

8. The apparatus of claim 7, wherein the searching module of the medium information displaying apparatus comprises:
a searching unit, searching a source file of the display medium for a preconfigured display position domain identifier;
an identification information obtaining unit, obtaining the identification information of the display position behind the display position domain identifier, when the display position domain identifier is searched out.

9. The apparatus of claim 7, wherein the displaying module of the medium information displaying apparatus comprises:
a display position finding unit, finding the at least one display position of the display medium according to the identification information of the at least one display position;
a medium information obtaining unit, obtaining the medium information according to the display data corresponding to the at least one display position; and
a displaying unit, displaying the medium information obtained on the display position corresponding to the medium information.

10. The apparatus of claim 7, further comprising: a medium information statistics apparatus at the network side;
wherein the medium information displaying apparatus further comprises a third sending module, sending an exposure statistics request to the medium information statistics apparatus after adding related information of each of display positions displaying the medium information in the exposure statistics request;
the medium information statistics apparatus comprises:
a third receiving module, receiving the exposure statistics request from the medium information displaying apparatus and obtaining the related information of each of the display positions displaying the medium information;
a statistics module, obtaining statistics according to the related information of each of the display positions displaying the medium information.

11. A method for displaying network medium information, comprising:
searching, by a terminal device, display positions of a display medium; obtaining identification information of at least one display position;
sending, by the terminal device, an information playing request to a network side after adding the identification information of the at least one display position into the information playing request;
receiving, by the terminal device, an information playing response from the network side; the information playing response comprising the identification information of the at least one display position and display data corresponding to the at least one display position;
obtaining, by the terminal device, the identification information of the at least one display position and the display data corresponding to the at least one display position from the information playing response; and
displaying, by the terminal device, medium information on the display position of the display medium according to the identification information of the at least one display position and the display data corresponding to the at least one display position.

12. The method of claim 11, wherein searching the display positions of the display medium and obtaining the identification information of the at least one display position comprises:
searching a source file of the display medium for a preconfigured display position domain identifier;
obtaining the identification information of the display position behind the display position domain identifier, when the display position domain identifier is searched out.

13. The method of claim 11, wherein displaying the medium information on the display position of the display medium according to the identification information of the at least one display position and the display data corresponding to the at least one display position comprises:
finding the at least one display position of the display medium according to the identification information of the at least one display position;
obtaining the medium information according to the display data corresponding to the at least one display position; and
displaying the medium information obtained on the display position corresponding to the medium information.

14. The method of claim 11, further comprising:
after displaying the medium information on the display position of the display medium according to the display data corresponding to the at least one display position,
sending, by the terminal device, an exposure statistics request to the network side after adding identification information of each of display positions displaying the medium information into the exposure statistics request; the exposure statistics request being used by the network side to obtain statistics for exposure data of each of the display positions displaying the medium information.

15. The method of claim 11, wherein the information playing response comprises a medium information order identifier corresponding to each of the at least one display position searched out by the network side; and
the method further comprises:
adding, by the terminal device, an medium information order identifier corresponding to each of the display positions displaying the medium information in the exposure statistics request, when generating the exposure statistics request comprising the identification information of each of display positions displaying the medium information; the exposure statistics request being used by the network side to obtain statistics for exposure data of medium information orders.

16. The method of claim 11, wherein the identification information of the display position comprises unique global identification information of the display position in a network medium information distributing system.
